(19) United States
(12) Patent Application Publication
(10) Pub. No.: US 2026/0290402 A1
(43) Pub. Date: Sep. 24, 2026

(54) BASE PLATE, MOTOR, DISK DRIVE DEVICE, AND METHOD FOR MANUFACTURING BASE PLATE

(71) Applicant: NIDEC CORPORATION, Kyoto (JP)

(72) Inventors: Michihiro ITO, Kyoto (JP); Kenta MIYOSHI, Kyoto (JP); Takashi MITSUNARI, Kyoto (JP); Genya ITAGAKI, Kyoto (JP)

(21) Appl. No.: 19/572,999

(22) Filed: Mar. 20, 2026

(30) Foreign Application Priority Data
Mar. 24, 2025 (JP) 2025-048901

(51) Int. Cl. G11B 33/12

(52) U.S. Cl. CPC G11B 33/124

(57) ABSTRACT

A base plate is a portion of a housing of a disk drive device and is made of a metal die-cast material. The base plate includes a bottom wall, a pivot post, and an annular pedestal. The bottom wall extends perpendicularly to a rotation axis of a disk that extends in a vertical direction and a swing axis of a head that reads or writes information from or to the disk. The pivot post protrudes upward from an upper surface of the bottom wall along the swing axis. The pedestal protrudes radially outward from an outer circumferential surface of a root portion of the pivot post. At least one of the upper surface or a lower surface of the bottom wall in a peripheral region on a radially outer side of the pedestal, and an upper surface of the pedestal, are cut surfaces.

### CROSS-REFERENCE TO RELATED APPLICATIONS

The present application claims priority under 35 U.S.C. § 119 to Japanese Patent Application No. 2025-048901 filed on Mar. 24, 2025, the entire contents of which are hereby incorporated herein by reference.

### 1. FIELD OF THE INVENTION

The present disclosure relates to base plates, motors, disk drive devices, and methods for manufacturing the base plates.

### 2. BACKGROUND

A base plate, which is a portion of a housing of a disk drive device in the related art, is made of a metal die-cast material and includes a bottom wall, a pivot post, and a pedestal. The bottom wall extends perpendicularly to a rotation axis of a disk extending in a vertical direction and a swing axis of a head. The head is disposed at a position different from the rotation axis, and reads or writes information from or to the disk (for example, see Japanese Patent Application Publication No. 2019-008856).

However, in the base plate disclosed in Japanese Patent Application Publication No. 2019-008856, the runner of the bottom wall toward the pivot post is narrow in the vertical direction on a radially outer side of the pedestal. Therefore, molten metal may be difficult to smoothly flow toward the pedestal during casting. This may cause a shrinkage cavity in a peripheral region of the pivot post, and reduce the strength of the pivot post. In addition, gas filled in the housing may leak to the outside through the shrinkage cavity.

### SUMMARY

A base plate according to an example embodiment of the present disclosure is a portion of a housing of a disk drive device, and is made of a metal die-cast material. The base plate includes a bottom wall, a pivot post, and a pedestal having an annular shape. The bottom wall extends perpendicularly to a rotation axis of a disk that extends in a vertical direction and a swing axis of a head configured to read or write information from or to the disk. The pivot post protrudes upward from an upper surface of the bottom wall along the swing axis. The pedestal protrudes radially outward from an outer circumferential surface of a root portion of the pivot post. At least one of the upper surface or a lower surface of the bottom wall in a peripheral region on a radially outer side of the pedestal, and an upper surface of the pedestal, are cut surfaces.

A method for manufacturing a base plate according to an example embodiment of the present disclosure is a method for manufacturing a base plate defining a portion of a housing of a disk drive device and includes a casting step and a precision cutting step in this order. In the casting step, a bottom wall, a pivot post, and a pedestal having an annular shape are integrally cast by using a mold. The bottom wall extends perpendicularly to a rotation axis of a disk that extends in a vertical direction and a swing axis of a head configured to read or write information from or to the disk. The pivot post protrudes upward from an upper surface of the bottom wall along the swing axis. The pedestal protrudes radially outward from an outer circumferential surface of a root portion of the pivot post. In the casting step, the bottom wall is integrally formed with a thick portion having a thickness of about 2.0 mm or more in the vertical direction in a peripheral region on a radially outer side of the pedestal. In the precision cutting step, the thick portion is cut, and a cut surface formed by cutting is formed on at least one of an upper surface or a lower surface of the bottom wall.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal cross-sectional view of a disk drive device according to an example embodiment of the present disclosure.

FIG. 2 is a perspective view schematically illustrating a base plate according to an example embodiment of the present disclosure.

FIG. 3 is a perspective view schematically illustrating a base plate according to an example embodiment of the present disclosure.

FIG. 4 is a top view schematically illustrating a base plate according to an example embodiment of the present disclosure.

FIG. 5 is a bottom view schematically illustrating a base plate according to an example embodiment of the present disclosure.

FIG. 6 is an enlarged top view illustrating a portion of a base plate according to an example embodiment of the present disclosure.

FIG. 7 is an enlarged bottom view illustrating a portion of a base plate according to an example embodiment of the present disclosure.

FIG. 8 is a flowchart illustrating a manufacturing process of a base plate according to an example embodiment of the present disclosure.

FIG. 9 is an explanatory view for explaining a manufacturing process of a base plate according to an example embodiment of the present disclosure.

FIG. 10 is an explanatory view for explaining a manufacturing process of a base plate according to an example embodiment of the present disclosure.

FIG. 11 is an explanatory view for explaining a manufacturing process of a base plate according to an example embodiment of the present disclosure.

FIG. 12 is an explanatory view for explaining a manufacturing process of a base plate according to an example embodiment of the present disclosure.

FIG. 13 is an explanatory view for explaining a manufacturing process of a base plate according to an example embodiment of the present disclosure.

FIG. 14 is an explanatory view for explaining a manufacturing process of a base plate according to an example embodiment of the present disclosure.

FIG. 15 is an enlarged top view illustrating a portion of a base plate according to an example embodiment of the present disclosure.

FIG. 16 is an enlarged bottom view illustrating a portion of a base plate according to an example embodiment of the present disclosure.

FIG. 17 is an explanatory view illustrating a modified example of a second recess portion and a third recess portion in FIG. 9 in an enlarged manner.

### DETAILED DESCRIPTION

Example embodiments of the present disclosure are described in detail below with reference to the drawings. In the present description, a direction parallel to a rotation axis J of a disk 50 is referred to as an “axial direction”, a direction orthogonal to the rotation axis J is referred to as a “radial direction”, and a direction along an arc centered on the rotation axis J is referred to as a “circumferential direction”. In the present application, the shape and positional relationship of each part are described with the axial direction as a vertical direction and a cover 42 side as an upper side with respect to a base plate 41. However, the definition of the vertical direction is not intended to limit the orientation of the base plate 41 and a disk drive device 1 according to the present disclosure during use.

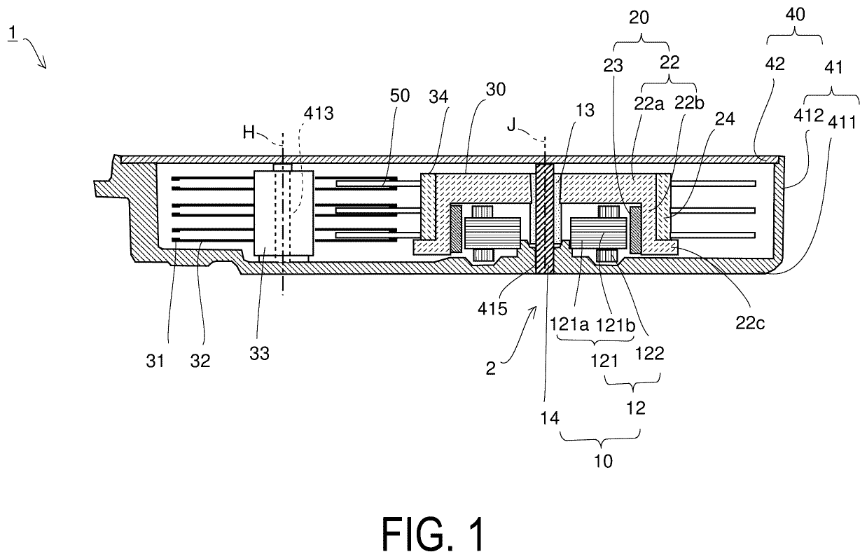

Disk drive devices according to example embodiments of the present disclosure are described. FIG. 1 is a longitudinal cross-sectional view of a disk drive device 1 according to a present example embodiment of the present disclosure.

The disk drive device 1 is a hard disk drive. The disk drive device 1 includes a spindle motor 2, the disk 50, a head 31, an arm 32, a driver 33, and a housing 40.

The housing 40 accommodates the spindle motor 2, the disk 50, the head 31, the arm 32, and the driver 33 therein.

The inside of the housing 40 is filled with gas having a lower density than air. This can reduce airflow resistance inside the housing 40, thereby reducing the vibration of the disk 50. Specifically, helium gas is filled. Instead of helium gas, hydrogen gas or the like may be filled.

The housing 40 is formed by casting a die-cast member made of an aluminum alloy. The die-cast member may be made of metal other than an aluminum alloy.

The housing 40 includes the base plate 41 and the cover 42. Inside the housing 40, the disk 50, the spindle motor 2, and the driver 33 are disposed on the base plate 41. An upper opening of the base plate 41 is closed by the cover 42. The base plate 41 is described below in detail.

The spindle motor 2 rotates the disk 50 about the rotation axis J while supporting the disk 50. That is, the disk 50 is rotated by the spindle motor 2 about the rotation axis J extending in the vertical direction. The spindle motor 2 includes a stationary portion 10 and a rotating portion 20. The stationary portion 10 is stationary relative to the housing 40. The rotating portion 20 is supported to be rotatable relative to the stationary portion 10.

The stationary portion 10 includes a shaft 14 and a stator 12. A portion of the base plate 41 constitutes the stationary portion 10. That is, the spindle motor 2 includes the base plate 41. The base plate 41 extends perpendicularly to the rotation axis J on a lower side of the rotating portion 20. The base plate 41 is a portion of the spindle motor 2 and also a portion of the housing 40. The stator 12 is fixed to the base plate 41.

The shaft 14 is a columnar metal member extending in the axial direction. A lower end portion of the shaft 14 is fixed to the base plate 41.

The stator 12 includes a stator core 121 that is a magnetic material and a plurality of coils 122. The stator core 121 includes an annular core back 121a and a plurality of teeth 121b. The core back 121a is disposed to surround the rotation axis J, and the plurality of teeth 121b fixed to the base plate 41 protrude radially outward from an outer circumferential surface of the core back 121a and are disposed in the circumferential direction. Each of the plurality of coils 122 includes a conductive wire wound around the teeth 121b.

A bearing unit 13 is integrally or separately coupled to a hub 22 of the rotating portion 20 side. The bearing unit 13 is disposed on an outer circumferential portion of the shaft 14 and rotatably supports the hub 22 with respect to the shaft 14. For example, a fluid dynamic bearing mechanism is used as the bearing unit 13.

The rotating portion 20 includes the hub 22 and a magnet 23. The hub 22 includes a top surface portion 22a and a tubular surface portion 22b. The top surface portion 22a is integrally or separately coupled to an outer circumferential portion of the bearing unit 13 and extends radially outward. The tubular surface portion 22b extends in the axial direction and is formed in a tubular shape, and includes a flange portion 22c extending radially outward from a lower end portion of the tubular surface portion 22b. A plurality of disks 50 are arranged in the axial direction on an outer circumferential surface of the tubular surface portion 22b.

The magnet 23 is fixed to an inner circumferential surface of the tubular surface portion 22b, and is disposed radially outward of the stator 12 while facing the stator 12 at a predetermined distance. The magnet 23 has an annular shape, and on an inner circumferential surface of the magnet 23, N poles and S poles are alternately magnetized in the circumferential direction.

When a drive current is supplied to the coil 122, magnetic fluxes are generated in the plurality of teeth 121b. In this case, the magnetic fluxes interact with each other between the teeth 121b and the magnet 23, so that a circumferential torque is generated. This causes the rotating portion 20 to rotate about the rotation axis J relative to the stationary portion 10. The disk 50 supported by the hub 22 rotates about the rotation axis J together with the rotating portion 20.

The disk 50 is a disk-shaped information recording medium having a hole in the center thereof. The disks 50 are mounted on the spindle motor 2 and are disposed in parallel to each other at equal intervals in the axial direction via spacers 24.

The head 31 magnetically reads and writes information from and to the disk 50. The arm 32 is attached to a pivot post 413 via a bearing (not illustrated). The head 31 is disposed at a tip portion of the arm 32. That is, the arm 32 has the head 31 disposed at the tip portion thereof and swings about a swing axis H.

The pivot post 413 protrudes upward from an upper surface of a bottom wall 411 of the base plate 41, which is described below, along the swing axis H, and is formed in a columnar shape.

The driver 33 is a mechanism for swinging the arm 32 and the head 31. When the driver 33 is driven, the head 31 is swung about the swing axis H by the driver 33 via the arm 32. In this case, the head 31 moves relative to the disk 50 and approaches the rotating disk 50 to access the disk 50.

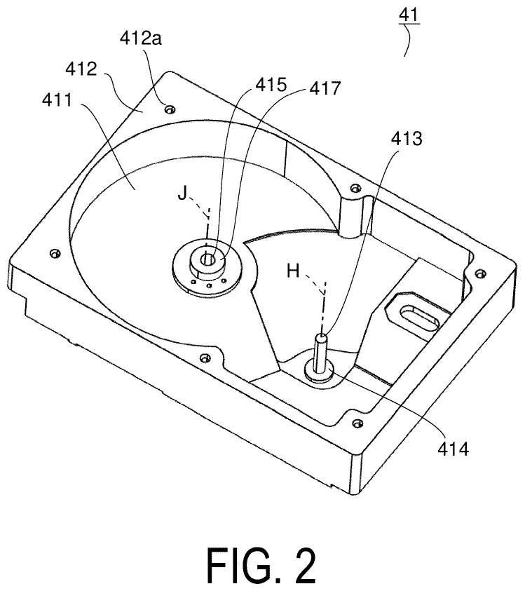

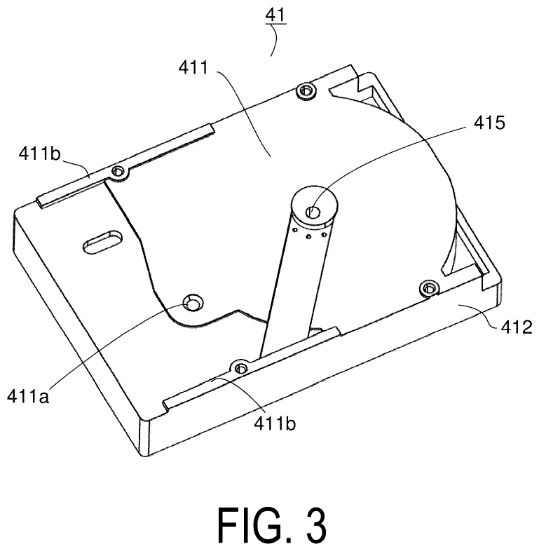

FIGS. 2 and 3 are perspective views schematically illustrating the base plate 41. FIG. 2 illustrates the base plate 41 when viewed from above, and FIG. 3 illustrates the base plate 41 when viewed from below. The base plate 41 includes the bottom wall 411, a circumferential wall 412, the pivot post 413, a pedestal 414, and a tubular wall 417.

In the present example embodiment, the bottom wall 411, the circumferential wall 412, the pivot post 413, the pedestal 414, and the tubular wall 417 are integrally formed as a casting product. The bottom wall 411 and the circumferential wall 412 are integrally formed as a casting product, but the bottom wall 411 and the circumferential wall 412, which are each cast as separate members, may be assembled to form the base plate 41.

The bottom wall 411 has a rectangular shape when viewed from the axial direction, and extends perpendicularly to the rotation axis J and the swing axis H extending in the vertical direction. The bottom wall 411 includes a pivot post recess portion 411a. The pivot post recess portion 411a is formed to be recessed along the swing axis H on a lower surface of the bottom wall 411.

The circumferential wall 412 extends axially upward from an outer circumferential edge of the bottom wall 411 and surrounds the periphery of the bottom wall 411. A plurality of screw holes 412a are formed in an upper end surface of the circumferential wall 412, and screws (not illustrated) are inserted into the screw holes 412a to screw the cover 42 to the base plate 41.

The pivot post 413 protrudes upward from the upper surface of the bottom wall 411 along the swing axis H. The driver 33 is supported by the bottom wall 411 via the pivot post 413 (see FIG. 1).

The pedestal 414 has an annular shape protruding radially outward from the outer circumferential surface of a root portion of the pivot post 413. By providing the pedestal 414, the strength of the pivot post 413 is improved. A bearing (not illustrated) constituting the driver 33 is disposed on the pedestal 414. By providing the pedestal 414, the positioning precision of the bearing (not illustrated) is improved, and the assembly workability is improved. The pedestal 414 is formed by cutting after casting so that the thickness in the vertical direction is uniform in the radial direction. Thus, the pivot post 413 is uniformly reinforced in the circumferential direction. Accordingly, the pivot post 413 can be further suppressed from being inclined with respect to the swing axis H.

The tubular wall 417 protrudes upward from an upper surface of the base plate 41 along the rotation axis J. The tubular wall 417 includes a shaft through-hole 415 that is disposed on the rotation axis J and penetrates the tubular wall 417 in the axial direction. The shaft 14 is press-fitted into the shaft through-hole 415, so that the bottom wall 411 and the shaft 14 are fixed to each other (see FIG. 1).

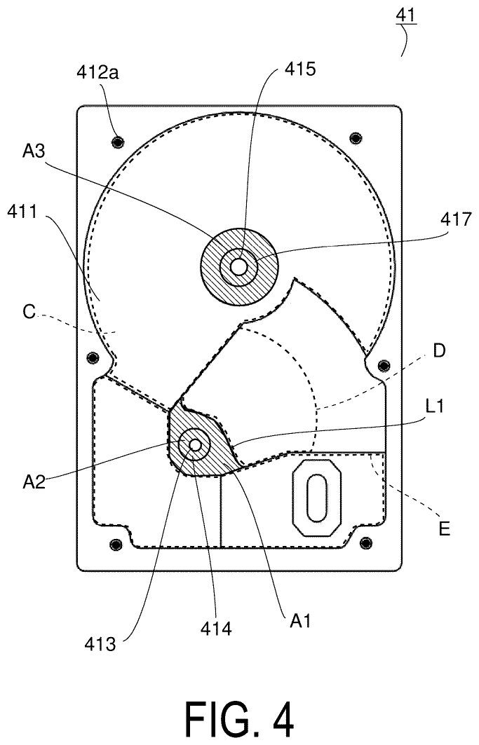

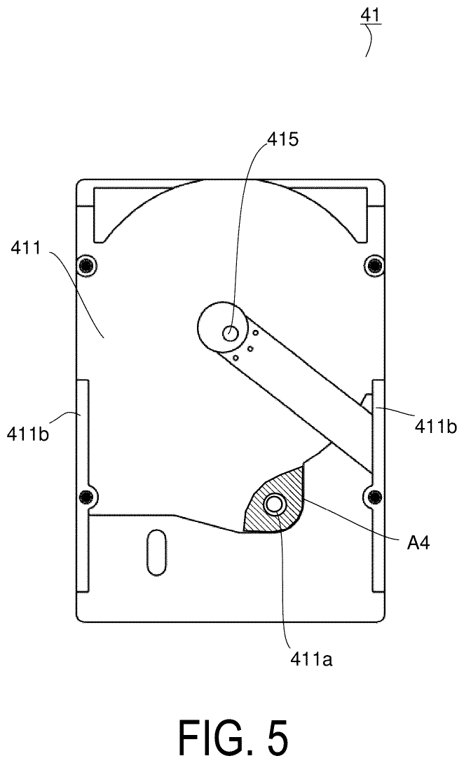

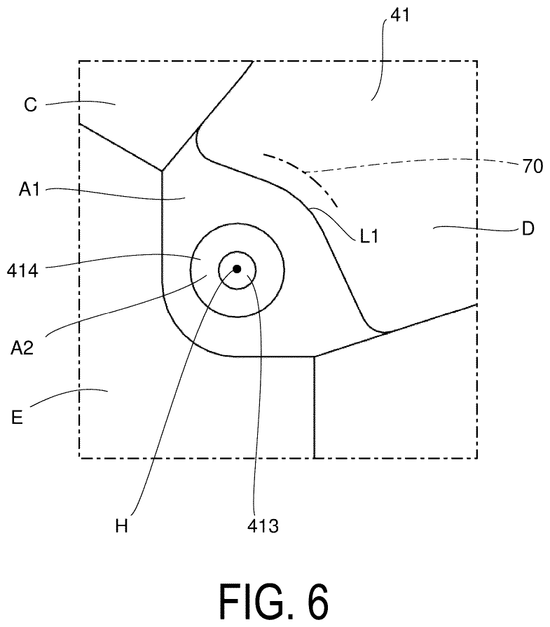

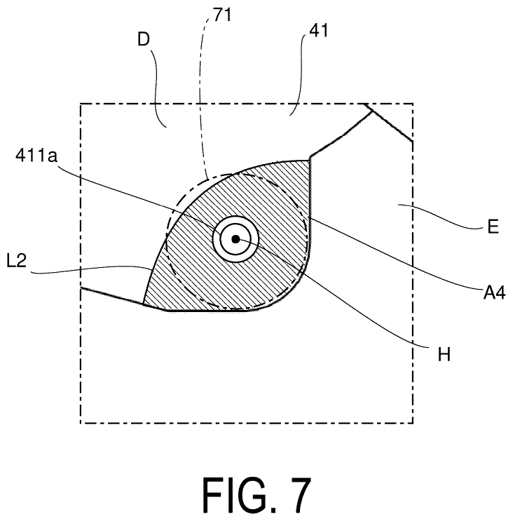

FIG. 4 is a top view of the base plate 41, and FIG. 5 is a bottom view of the base plate 41. FIG. 6 is an enlarged top view illustrating the periphery of the pivot post 413 of the base plate 41, and FIG. 7 is an enlarged bottom view illustrating the periphery of the pivot post 413 of the base plate 41. In FIG. 4, a disk facing region C, an arm swing region D, and a driver mounting region E are indicated by broken lines. In FIGS. 4 and 5, cut surfaces A1, A2, A3, and A4 are hatched for the sake of description.

The cut surfaces A1, A2, and A3 are formed on the upper surface of the bottom wall 411, and the cut surface A4 is formed on the lower surface of the bottom wall 411. The cut surface A2 is formed by cutting an outer circumferential surface of the pivot post 413 and an upper surface and an outer circumferential surface of the pedestal 414. The cut surface A3 is formed by cutting an upper surface and an outer circumferential surface of the tubular wall 417.

In the present example embodiment, the cut surfaces A1 and A4 are formed on the upper surface and the lower surface of the bottom wall 411, respectively; however, one of the cut surfaces A1 and A4 may be omitted. That is, at least one of the upper surface or the lower surface of the bottom wall 411 in a peripheral region on the radially outer side of the pedestal 414, and the upper surface of the pedestal 414 are the cut surfaces A1, A2, and A4.

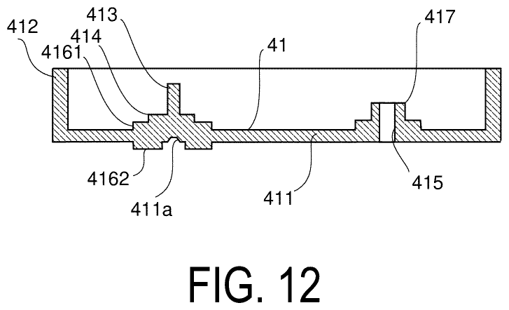

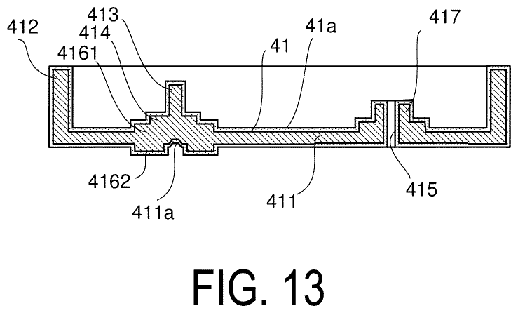

The cut surface A1 is formed by cutting a thick portion 4161 formed on the upper surface of the bottom wall 411 in the peripheral region on the radially outer side of the pedestal 414 in a method for manufacturing the base plate 41 to be described below (see FIGS. 12 and 13).

The cut surface A4 is formed by cutting a thick portion 4162 formed on the lower surface of the bottom wall 411 in the peripheral region on the radially outer side of the pedestal 414.

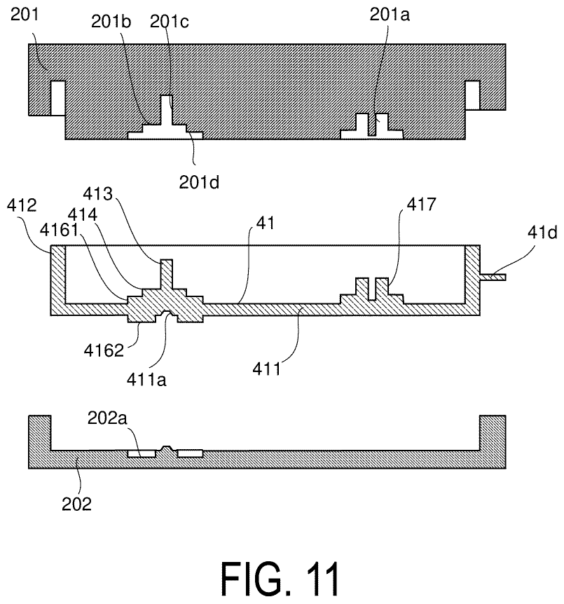

The thick portion 4161 is protruding upward from the upper surface of the bottom wall 411 in the peripheral region on the radially outer side of the pedestal 414 when the pedestal 414 is cast (see FIG. 11). The thick portion 4162 is protruding downward from the lower surface of the bottom wall 411 in the peripheral region on the radially outer side of the pedestal 414.

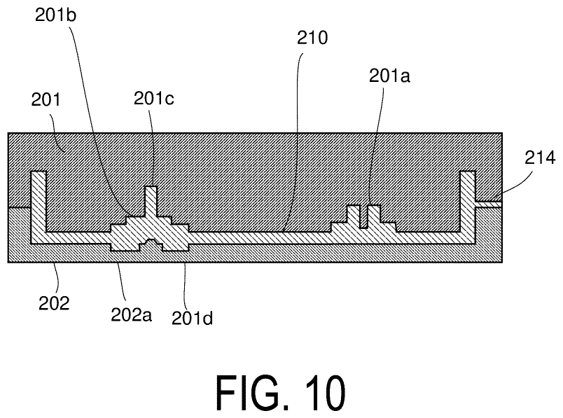

When the pedestal 414 is cast, the thick portions 4161 and 4162 are formed, so that in the bottom wall 411, the peripheral region on the radially outer side of the pedestal 414 is thick in the vertical direction. Thus, the runner of the bottom wall 411 toward the pivot post 413 extends in the vertical direction. Accordingly, during casting, molten metal smoothly flows from the thick portions 4161 and 4162 toward the pedestal 414 (see FIG. 10). This can reduce the occurrence of shrinkage cavities in the pedestal 414. Accordingly, a decrease in the strength of the pivot post 413 can be suppressed.

An upper end of the thick portion 4161 before the cutting is located below an upper end of the pedestal 414 before the cutting. This allows the molten metal to flow more smoothly from the thick portion 4161 toward the pedestal 414 during casting.

This can reduce the occurrence of shrinkage cavities remaining in the pedestal 414 and the peripheral region on the radially outer side of the pedestal 414. Accordingly, leakage of the gas filled in the housing 40 to the outside through the shrinkage cavity can be reduced.

The bottom wall 411 has a reduced thickness in the vertical direction, thereby increasing the capacity of the housing 40. This can increase the number of disks 50 mounted on the disk drive device 1 and increase the storage capacity. On the other hand, the bottom wall 411 preferably has a thickness of about 0.9 mm or more in the vertical direction at the cut surfaces A1 and A4. By increasing the thickness of the bottom wall 411, leakage of the gas filled in the housing 40 to the outside through the shrinkage cavity can be further reduced.

In the present example embodiment, the thick portion 4161 and the thick portion 4162 are formed separately on the upper surface and the lower surface of the bottom wall 411, respectively, and at least a portion of the cut surface A1 formed on the upper surface of the bottom wall 411 overlaps, in the axial direction, the cut surface A4 formed on the lower surface of the bottom wall 411. By providing the thick portion 4161 and the thick portion 4162 to thicken the bottom wall 411 in the vertical direction, an external force applied to the bottom wall 411 during cutting is dispersed to the upper surface and the lower surface, as compared with a case where only one of the upper surface or the lower surface of the bottom wall 411 is formed to be thick. This can suppress the bottom wall 411 from warping due to internal residual stress during cutting, and suppress the bottom wall 411 from being distorted and deformed.

The base plate 41 includes the disk facing region C, the arm swing region D, and the driver mounting region E that are non-cutting regions that are not cut after casting. The arm swing region D faces, in the vertical direction, the arm 32 swinging about the swing axis H. In the driver mounting region E, an actuator (not illustrated) and a circuit board (not illustrated) included in the driver 33 that swings the arm 32 are disposed. The disk facing region C includes a region sandwiched between the arm swing region D and the driver mounting region E in the circumferential direction of the swing axis H, and a region facing the disk 50 in the vertical direction.

The disk facing region C, the arm swing region D, and the driver mounting region E are arranged in order in a clockwise direction around the swing axis H so as to surround the cut surfaces A1 and A2 when viewed from above in the axial direction.

The cut surfaces A1 and A2 are surrounded by the disk facing region C, the arm swing region D, and the driver mounting region E in the bottom wall 411. Thus, the formation region of the cut surface A1 is narrowed to a peripheral region of the pivot post 413, thereby improving the work efficiency of the cutting.

More specifically, at least a portion of a circumferential edge L1 of the cut surface A1 facing the arm swing region D in the radial direction is located inside an arc 70 with a radius of about 9.0 mm centered on the swing axis H when viewed from the axial direction. This can further improve the workability of the cutting by further narrowing the formation region of the cut surface A1 in the radial direction. In addition, the arm swing region D can be formed to be wider on the pivot post 413 side.

The cut surface A2 is preferably formed to be flush with the upper surface of the bottom wall 411 in the arm swing region D or to be recessed downward in the axial direction. This can prevent the arm 32 from contacting the cut surface A2.

At least a portion of a circumferential edge L2 of the cut surface A4 facing the arm swing region D in the radial direction overlaps an arc 71 with a radius equal to the shortest distance between the swing axis H and the driver mounting region E when viewed from the axial direction (see FIG. 7). Thus, the cut surface A4 is formed to be wide outward in the radial direction. Accordingly, the flow of the molten metal in casting is further improved, so that the occurrence of shrinkage cavities can be further reduced. Accordingly, a decrease in the strength of the pivot post 413 can be further suppressed.

The cut surface A4 is preferably located axially above an attachment surface 411b disposed on the circumferential edge of the lower surface of the bottom wall 411 (see FIGS. 3 and 5). This can prevent the disk drive device 1 from being inclined with respect to the installation surface.

The bottom wall 411 including the disk facing region C, the arm swing region D, and the driver mounting region E is at least partially covered with an electrodeposition coating film, and the cut surfaces A1, A2, A3, and A4 are regions not covered with the electrodeposition coating film. An impregnating agent easily infiltrates into the cut surfaces A1, A2, A3, and A4 not covered with the electrodeposition coating film. Thus, minute cavities formed on the cut surfaces A1, A2, A3, and A4 during casting are sealed with the impregnating agent. Accordingly, the gas filled in the housing 40 can be further suppressed from leaking to the outside.

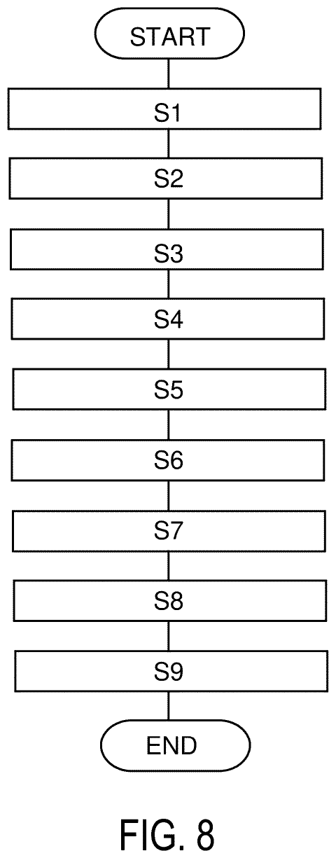

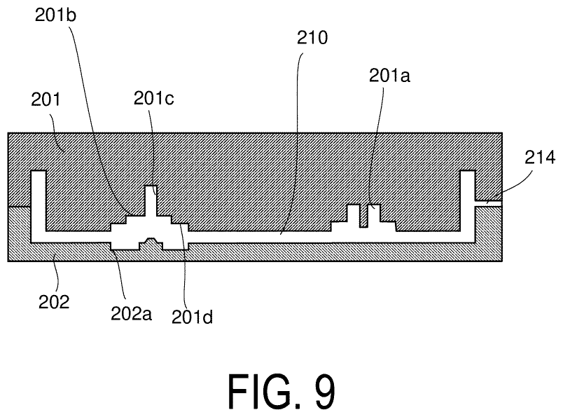

FIG. 8 is a flowchart illustrating a manufacturing process of the base plate 41. FIGS. 9 to 15 are explanatory views for explaining the manufacturing process of the base plate.

In step S1, as illustrated in FIG. 9, a circumferential edge portion of a mold 202 and a circumferential edge portion of a mold 201 are brought into contact with each other in the vertical direction, so that a cavity 210 is formed between the mold 201 and the mold 202. The cavity 210 has a shape corresponding to the shape of the base plate 41. The cavity 210 also communicates with a gate 214 that extends along facing surfaces of the mold 201 and the mold 202. An outer end portion of the gate 214 is open to the outside of the mold 201 and the mold 202.

In addition, an air vent passage (not illustrated) for venting air in the cavity 210 is provided on the facing surfaces of the mold 201 and the mold 202, separately from the gate 214. An outer end portion of the air vent passage is open to the outside of the mold 201 and the mold 202.

The mold 201 includes a first recess portion 201a and a second recess portion 201b. The first recess portion 201a is formed by recessing a lower surface of the mold 201 upward in the axial direction along the rotation axis J. The inside of the first recess portion 201a communicates with the cavity 210.

The second recess portion 201b is formed by recessing the lower surface of the mold 201 upward in the axial direction along the swing axis H. The inside of the second recess portion 201b communicates with the cavity 210. A protruding recess portion 201c protruding upward is formed on a top surface of the second recess portion 201b. In addition, an enlarged-diameter portion 201d that extends radially outward is formed at the lower end portion of an inner circumferential surface of the second recess portion 201b.

Molten metal flows into the inside of the first recess portion 201a to form the tubular wall 417. In addition, the molten metal flows into the inside of the second recess portion 201b to form the pedestal 414. In addition, the molten metal flows into the inside of the protruding recess portion 201c to form the pivot post 413. In addition, the molten metal flows into the inside of the enlarged-diameter portion 201d to form the thick portion 4161.

The mold 202 includes a third recess portion 202a. The third recess portion 202a is formed by recessing an upper surface of the mold 202 downward in the axial direction along the swing axis H. The inside of the third recess portion 202a communicates with the cavity 210. The molten metal flows into the inside of the third recess portion 202a to form the thick portion 4162.

In step S2, as illustrated in FIG. 10, molten metal is injected into the cavity 210 via the gate 214. The molten metal is, for example, a molten aluminum alloy. When the molten metal is injected into the cavity 210, air in the cavity 210 or gas generated from the molten metal is pushed out from the air vent passage to the outside of the mold 201 and the mold 202. This allows the molten metal to spread throughout the entire cavity 210.

In this case, runners of the enlarged-diameter portion 201d and the third recess portion 202a extend in the vertical direction. Therefore, the molten metal smoothly flows from the second recess portion 201b toward the protruding recess portion 201c.

In step S3, after the molten metal spreads in the cavity 210, the molten metal is cooled and cured. Thus, the base plate 41 is formed in the cavity 210. A chill layer (not illustrated) is formed on the surface of the base plate 41. The chill layer is formed in a place where the molten metal is in contact with the mold 201 and the mold 202 and is rapidly cured when the molten metal is cured. The chill layer, where the molten metal is cured faster than other parts, has less impurities and a higher metal density. In addition, the enlarged-diameter portion 201d, the second recess portion 201b, and the third recess portion 202a through which the molten metal smoothly flows are less likely to have a shrinkage cavity when the molten metal is cured.

In step S4, as illustrated in FIG. 11, the base plate 41 is released from the pair of molds 201 and 202. In this case, the circumferential wall 412 includes a gate mark portion 41d protruding from the outer surface thereof. The gate mark portion 41d is formed by curing the molten metal accumulated in the gate 214 and the air vent passage (not illustrated).

In step S5, as illustrated in FIG. 12, the gate mark portion 41d is cut. The trace of cutting the gate mark portion 41d remains slightly protruding from the outer surface of the circumferential wall 412.

In step S6, the tubular wall 417 is cut in the axial direction to penetrate the bottom wall 411 in the axial direction. Thus, the shaft through-hole 415 is formed by the cutting.

In step S7, as illustrated in FIG. 13, an electrodeposition coating film 41a is formed on the surface of the base plate 41. In order to form the electrodeposition coating film 41a, for example, the base plate 41 is immersed in a coating material of an epoxy resin and a current is allowed to flow between the coating material and the base plate 41. Thus, the coating material adheres to the surface of the base plate 41 and the electrodeposition coating film 41a is formed. In this case, the machined region cut in step S6 is also covered with the electrodeposition coating film 41a. By covering the base plate 41 with the electrodeposition coating film 41a, the insulation of the base plate 41 is improved and the leakage of gas passing through the base plate 41 can be reduced.

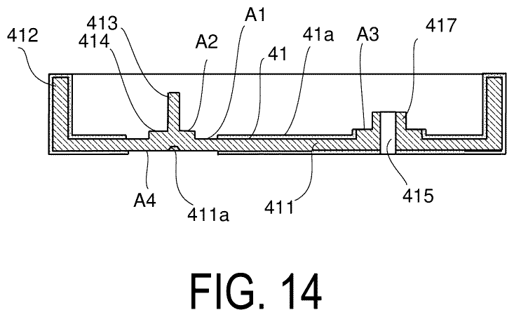

In step S8, as illustrated in FIG. 14, regions of the surface of the base plate 41 that require precision are precisely machined by cutting to form the cut surfaces A1, A2, A3, and A4. Specifically, the cut surface A2 is formed on the outer circumferential surface of the pivot post 413 and the upper surface and the outer circumferential surface of the pedestal 414, and the cut surface A1 is formed on the thick portion 4161 cut on the upper surface of the bottom wall 411. In addition, the cut surface A4 is formed in a peripheral region on the radially outer side of the pivot post recess portion 411a on the lower surface of the bottom wall 411. In addition, the cut surface A3 is formed on the inner circumferential surface of the shaft through-hole 415 and the upper surface and the outer circumferential surface of the tubular wall 417.

In this case, the electrodeposition coating film 41a is also cut by cutting the surface of the base plate 41, and the cut surfaces A1, A2, A3, and A4 are regions not provided with the electrodeposition coating film 41a.

In step S9, the base plate 41 is immersed in the impregnating agent. Thus, the impregnating agent infiltrates into the cut surfaces A1, A2, A3, and A4. As the impregnating agent, for example, an epoxy resin or an acrylic resin is used. Thus, minute cavities formed on the cut surfaces A1, A2, A3, and A4 during casting are sealed with the impregnating agent.

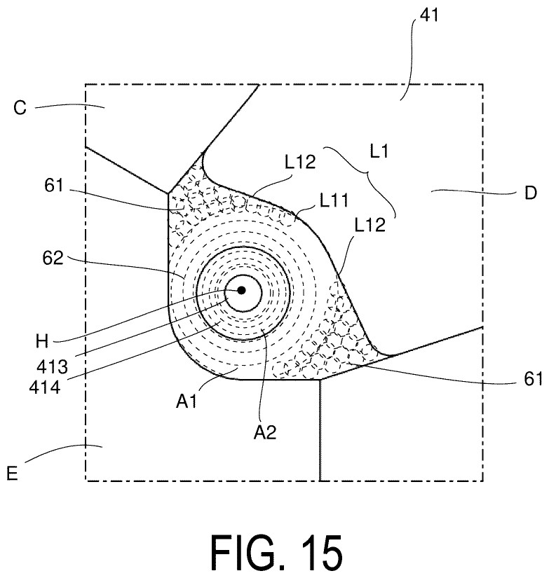

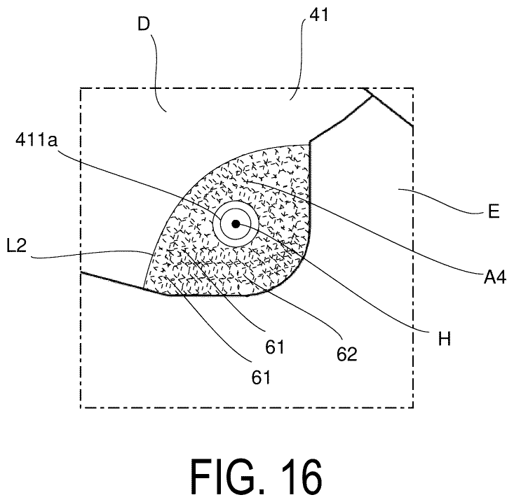

FIG. 15 is an enlarged top view illustrating the periphery of the pivot post 413 of the base plate 41, and FIG. 16 is an enlarged bottom view illustrating the periphery of the pivot post 413 of the base plate 41. In FIGS. 15 and 16, cutting marks (first cutting marks) 61 and cutting marks (second cutting marks) 62 are indicated by dotted lines. In the present example embodiment, in step S8, the surface of the bottom wall 411 is cut by using two types of cutting tools. One (hollow mill) of the cutting tools has a cutting blade that rotates about the swing axis H to cut the surface of the bottom wall 411. The other (end mill) of the cutting tools moves a rotating cutting blade along the surface of the bottom wall 411. The cutting tool (hollow mill) can cut a wide region in a short time. On the other hand, the cutting tool (end mill) has a cutting blade smaller than the cutting blade of the cutting tool (hollow mill), and can cut precisely a narrow region.

More specifically, the cutting tool (hollow mill) is disposed with the cutting blade across the upper surface of the pedestal 414, the outer circumferential surface of the pedestal 414, and the upper surface of the thick portion 4161. The cutting blade can simultaneously cut the upper surface of the pedestal 414, the outer circumferential surface of the pedestal 414, and the upper surface of the thick portion 4161 by rotating about the swing axis H. In this case, a plurality of annular cutting marks (second cutting marks) 62 arranged concentrically about the swing axis H are formed on the upper surface of the pedestal 414 and the cut thick portion 4161. That is, the cut surfaces A1 and A2 have the plurality of annular cutting marks (second cutting marks) 62 arranged concentrically about the swing axis H. This can improve the work efficiency of the cutting.

The circumferential edge L1 of the cut surface A1 includes a convex portion L11 and straight portions L12. The convex portion L11 is protruding outward in the radial direction of the swing axis H when viewed from the axial direction. The straight portions L12 extend linearly in the circumferential direction from both ends of the convex portion L11 in the circumferential direction. The cutting tool (hollow mill) can efficiently form the cut surface A1 along the convex portion L11. In addition, the cutting tool (end mill) can efficiently form the cut surface A1 along the straight portion L12. Accordingly, the work efficiency of the cutting can be further improved. In addition, the shape of the circumferential edge L1 can prevent the arm 32 from coming into contact with components disposed inside the housing 40.

A region of the thick portion 4161 that has not been cut by the cutting tool (hollow mill) is cut by using the cutting tool (end mill). Since the cutting blade of the cutting tool (end mill) moves on the thick portion 4161 while rotating, a plurality of annular cutting marks (first cutting marks) 61 are formed continuously. That is, the cut surface A1 includes the plurality of annular cutting marks (first cutting marks) 61 arranged continuously. By miniaturizing the cutting blade of the cutting tool (end mill), the cutting can be performed while improving dimensional precision. Accordingly, the thick portion 4161 on the cut surface A1 can be cut with high precision.

In the present example embodiment, a circular wide region centered on the swing axis H is cut by the cutting tool (hollow mill), and a region that is not cuttable by the cutting tool (hollow mill) is cut by the cutting tool (end mill). Thus, the cut surface A1 includes the cutting marks (first cutting marks) 61 and the cutting marks (second cutting marks) 62 disposed radially inward of the cutting marks (first cutting marks) 61. Accordingly, a wide region on the inner circumferential side of the cut surface A1 centered on the swing axis H can be efficiently cut in a short time, and a narrow region on the outer circumferential side of the cut surface A1 can be cut with high precision.

The thick portion 4162 is cut by using the cutting tool (end mill). Thus, the cut surface A4 is formed radially outward of the pivot post recess portion 411a and includes the annular cutting marks (first cutting marks) 61. The plurality of cutting marks (first cutting marks) 61 are continuously arranged.

The thick portions 4161 and 4162 may be cut by using only one of the cutting tool (hollow mill) and the cutting tool (end mill). In this case, only one of the cutting mark (first cutting mark) 61 and the cutting mark (second cutting mark) 62 is formed on the cut surfaces A1, A2, and A4.

As described above, the method for manufacturing the base plate 41 as a cast product, which is a portion of the housing 40 of the disk drive device 1, includes a casting step, a cutting step, an electrodeposition coating step, a precision cutting step, and an impregnation step in this order. In the casting step, the bottom wall 411, the pivot post 413, the pedestal 414, and the tubular wall 417 are integrally cast by using a mold (steps S1 to S4). In the cutting step, a portion of the tubular wall 417 is cut (step S6). In the electrodeposition coating step, the electrodeposition coating film 41a is formed on the surface of the base plate 41 (step S7). In the precision cutting step, a portion of the bottom wall 411 is cut. More specifically, a region of the surface of the base plate 41 that requires precision is precisely machined and shaped by cutting (step S8). In the impregnation step, a region of the surface of the base plate 41 exposed from the electrodeposition coating film 41a is impregnated with an impregnating agent (step S9).

In the present example embodiment, in the casting step, the bottom wall 411 is integrally formed with the thick portions 4161 and 4162 each having a thickness of about 2.0 mm or more in the vertical direction in the peripheral region on the radially outer side of the pedestal 414. In the precision cutting step, the thick portions 4161 and 4162 are cut, and the cut surfaces A1 and A2 formed by cutting are formed on at least one of the upper surface or the lower surface of the bottom wall 411.

In the casting step, the thick portions 4161 and 4162 each having a thickness of about 2.0 mm or more in the vertical direction are formed, so that the bottom wall 411 has a thick peripheral region on the radially outer side of the pedestal 414 in the vertical direction. Thus, the runner of the bottom wall 411 toward the pivot post 413 extends in the vertical direction in the peripheral region on the radially outer side of the pedestal 414. Accordingly, during casting, the molten metal smoothly flows from the thick portions 4161 and 4162 toward the pedestal 414. This can reduce the occurrence of shrinkage cavities in the pedestal 414. Accordingly, a decrease in the strength of the pivot post 413 can be suppressed.

In addition, the occurrence of shrinkage cavities remaining in the pedestal 414 and the peripheral region on the radially outer side of the pedestal 414 can be reduced. Accordingly, leakage of the gas filled in the housing 40 to the outside through the shrinkage cavity can be reduced.

In the precision cutting step, the thick portion 4162 is cut by moving the rotating cutting blade using the cutting tool (end mill). In addition, the thick portion 4161 is cut by rotating the cutting blade about the swing axis H using the cutting tool (hollow mill). Thus, wide regions of the thick portions 4161 and 4162 are efficiently cut in a short time by the cutting tool (hollow mill). In addition, narrow regions of the thick portions 4161 and 4162 can be cut with high precision using the cutting tool (end mill).

The bottom wall 411 preferably has a thickness of about 0.9 mm or more in the vertical direction after the cutting. By increasing the thickness of the bottom wall 411, leakage of the gas filled in the housing 40 to the outside through the shrinkage cavity can be further reduced.

In the precision cutting step, the cutting blade of the cutting tool (hollow mill) is disposed across the upper surface of the pedestal 414 and the outer circumferential surface of the pedestal 414. This allows the upper surface of the pedestal 414 and the outer circumferential surface of the pedestal 414 to be cut simultaneously. Accordingly, the work efficiency of the cutting can be further improved.

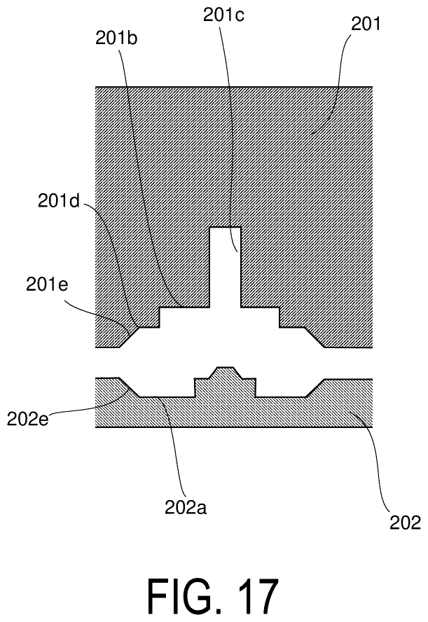

FIG. 17 is an explanatory view illustrating a modified example of the second recess portion 201b and the third recess portion 202a in FIG. 9 in an enlarged manner. The second recess portion 201b includes an inclined surface 201e and the third recess portion 202a includes an inclined surface 202e. The inclined surface 201e is disposed at a radially outer end portion of a top surface of the enlarged-diameter portion 201d and has an annular shape when viewed from the axial direction. The inclined surface 201e is inclined upward in the axial direction as it extends radially inward. The inclined surface 202e is disposed at a radially outer end portion of a bottom surface of the third recess portion 202a, and has an annular shape when viewed from the axial direction. The inclined surface 202e is inclined downward in the axial direction as it extends radially inward. One of the inclined surface 201e and the inclined surface 202e may be omitted.

By forming the inclined surface 201e and the inclined surface 202e, the molten metal smoothly flows toward the enlarged-diameter portion 201d and the third recess portion 202a, respectively. This allows the molten metal to smoothly flow along the inclined surface 201e and the inclined surface 202e. Accordingly, the shrinkage cavity is less likely to occur in the enlarged-diameter portion 201d and the third recess portion 202a.

The above-described example embodiments are merely illustrative of the present disclosure. The configurations of the example embodiments may be appropriately changed without departing from the technical ideas of the present disclosure. In addition, the example embodiments may be combined with each other within a feasible range. For example, in the present example embodiment, the thick portion 4161 and the thick portion 4162 are provided on the bottom wall 411; however, one of the thick portion 4161 and the thick portion 4162 may be omitted.

In addition, in the present example embodiment, the cut surface A2 is formed by cutting the upper surface and the outer circumferential surface of the pedestal 414; however, the cutting of the outer circumferential surface of the pedestal 414 may be omitted.

In addition, in the present example embodiment, the thick portion 4162 is cut using only the cutting tool (end mill); however, the thick portion 4162 may be cut using the cutting tool (end mill) and the cutting tool (hollow mill) similarly to the thick portion 4161.

In the present example embodiment, the cut surfaces A1, A2, A3, and A4 are formed by precision cutting after the electrodeposition coating film 41a is formed on the surface of the base plate 41; however, the electrodeposition coating film 41a may be formed on the surface of the base plate 41 after any one of the cut surfaces A1, A2, A3, and A4 is formed.

That is, the precision cutting step is performed before and after the electrodeposition coating step. Thus, the method for manufacturing the base plate 41 includes the casting step, the cutting step, a first precision cutting step, the electrodeposition coating step, a second precision cutting step, and the impregnation step in this order. In this case, for example, the cut surface A2 may be formed in the first precision cutting step, and the cut surface A1 may be formed in the second precision cutting step. Thus, the cut surface A2 is covered with the electrodeposition coating film 41a, so that the insulation of the base plate 41 is further improved and the leakage of gas passing through the base plate 41 can be further reduced. All of the cut surfaces A1, A2, A3, and A4 may be formed in the first precision cutting step.

As described above, a base plate (41) according to an example embodiment of the present disclosure is a base plate defining a portion of a housing (40) of a disk drive device (1) and made of a metal die-cast material, and includes a bottom wall (411) extending perpendicularly to a rotation axis (J) of a disk (50) that extends in a vertical direction and a swing axis (H) of a head (31) configured to read or write information from or to the disk, a pivot post (413) protruding upward from an upper surface of the bottom wall along the swing axis, and a pedestal (414) having an annular shape and protruding radially outward from an outer circumferential surface of a root portion of the pivot post. At least one of the upper surface or a lower surface of the bottom wall in a peripheral region on a radially outer side of the pedestal, and an upper surface of the pedestal, are each a cut surface (A1, A2) (first configuration).

In the first configuration, at least a portion of the bottom wall may be covered with an electrodeposition coating film (41a), and the cut surface may be a region not covered with the electrodeposition coating film (second configuration).

In the first or second configuration, the bottom wall may include an arm swing region (D) facing, in the vertical direction, an arm (32) configured to swing about the swing axis, the head being located at a tip portion of the arm, a driver mounting region (E) on which a driver (33) is located, the driver configured to swing the arm, and a disk facing region (C) including a region sandwiched between the arm swing region and the driver mounting region in a circumferential direction of the swing axis and a region facing the disk in the vertical direction, and a circumferential edge of the cut surface may be located closer to the swing axis than a circumferential edge of the disk facing region, a circumferential edge of the arm swing region, and a circumferential edge of the driver mounting region when viewed from an axial direction (third configuration).

In any one of the first to third configurations, at least a portion of a circumferential edge (L1) of the cut surface on an upper surface of the bottom wall may be located inside an arc (70) with a radius of about 9.0 mm centered on the swing axis when viewed from the axial direction, the circumferential edge facing the arm swing region in a radial direction (fourth configuration).

In any one of the first to fourth configurations, the circumferential edge (L1) of the cut surface on the upper surface of the bottom wall may include a convex portion (L11) protruding outward in a radial direction of the swing axis and straight portions (L12) extending linearly in a circumferential direction from both ends of the convex portion in the circumferential direction when viewed from the axial direction, the circumferential edge facing the arm swing region in the radial direction (fifth configuration).

In any one of the first to fifth configurations, at least a portion of a circumferential edge (L2) of the cut surface on a lower surface of the bottom wall may overlap an arc (71) with a radius equal to a shortest distance between the swing axis and the driver mounting region when viewed from e axial direction, the circumferential edge facing the arm swing region in a radial direction (sixth configuration).

In any one of the first to sixth configurations, the cut surface may be provided on each of the upper surface and the lower surface of the bottom wall, and at least a portion of the cut surface on the upper surface of the bottom wall may overlap, in an axial direction, the cut surface on the lower surface of the bottom wall (seventh configuration).

In any one of the first to seventh configurations, the cut surface on the upper surface of the bottom wall may include a plurality of annular first cutting marks (61) arranged continuously in a circumferential direction about the swing axis (eighth configuration).

In any one of the first to eighth configurations, the cut surface may include a plurality of annular second cutting marks (62) arranged concentrically about the swing axis (ninth configuration).

In any one of the first to ninth configurations, the cut surface may include the plurality of circular first cutting marks (61) arranged continuously in a circumferential direction about the swing axis, and the plurality of second cutting marks (62) located radially inward of the plurality of circular first cutting marks and arranged concentrically about the swing axis (tenth configuration).

In any one of the first to tenth configurations, the bottom wall may have a thickness of about 0.9 mm or more in the vertical direction at the cut surface (eleventh configuration).

A spindle motor (2) according to an example embodiment of the present disclosure may include the base plate (41) of any one of the first to eleventh configurations (twelfth configuration).

A disk drive device (1) according to an example embodiment of the present disclosure may include the spindle motor (2) of the twelfth configuration, a disk (50) configured to be rotated by the spindle motor about the rotation axis, and a head (31) configured to read or write information from or to the disk (thirteenth configuration).

In the thirteenth configuration, the housing may be filled with gas having a lower density than air (fourteenth configuration).

A method for manufacturing a base plate according to an example embodiment of the present disclosure is a method for manufacturing a base plate (41) being a portion of a housing (40) of a disk drive device (1) and includes, in this order, a casting step of integrally casting, by using a mold, a bottom wall (411) extending perpendicularly to a rotation axis (J) of a disk (50), the rotation axis extending in a vertical direction and a swing axis (H) of a head (31) configured to read or write information from or to the disk, a pivot post (413) protruding upward from an upper surface of the bottom wall along the swing axis, and a pedestal (414) having an annular shape and protruding radially outward from an outer circumferential surface of a root portion of the pivot post, and a precision cutting step of cutting a portion of the bottom wall. In the casting step, the bottom wall is integrally formed with a thick portion (4161, 4162) having a thickness of about 2.0 mm or more in the vertical direction in a peripheral region on a radially outer side of the pedestal, and in the precision cutting step, the thick portion is cut and a cut surface (A1, A2) formed by cutting is formed on at least one of an upper surface or a lower surface of the bottom wall (fifteenth configuration).

In the fifteenth configuration, in the precision cutting step, the thick portion may be cut by moving a rotating cutting blade (sixteenth configuration).

In the fifteenth or sixteenth configuration, in the precision cutting step, the thick portion may be cut by rotating a cutting blade about the swing axis (seventeenth configuration).

In the seventeenth configuration, in the precision cutting step, the cutting blade may be positioned across an upper surface of the pedestal and an outer circumferential surface of the pedestal (eighteenth configuration).

In any one of the fifteenth to eighteenth configurations, the bottom wall may have a thickness of about 0.9 mm or more in the vertical direction after precision cutting (nineteenth configuration).

Example embodiments of the present disclosure can be used in disk drive devices such as hard disk drives.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A base plate defining a portion of a housing of a disk drive device and made of a metal die-cast material, the base plate comprising:
a bottom wall extending perpendicularly to a rotation axis of a disk that extends in a vertical direction and a swing axis of a head configured to read or write information from or to the disk;
a pivot post protruding upward from an upper surface of the bottom wall along the swing axis; and
a pedestal having an annular shape and protruding radially outward from an outer circumferential surface of a root portion of the pivot post; wherein
at least one of the upper surface or a lower surface of the bottom wall in a peripheral region on a radially outer side of the pedestal, and an upper surface of the pedestal, are cut surfaces.

2. The base plate according to claim 1, wherein
at least a portion of the bottom wall is covered with an electrodeposition coating film; and
the cut surface is a region not covered with the electrodeposition coating film.

3. The base plate according to claim 1, wherein
the bottom wall includes an arm swing region facing, in the vertical direction, an arm configured to swing about the swing axis, the head being located at a tip portion of the arm, a driver mounting region on which a driver is located, the driver configured to swing the arm, and a disk facing region including a region sandwiched between the arm swing region and the driver mounting region in a circumferential direction of the swing axis and a region facing the disk in the vertical direction; and
a circumferential edge of the cut surface is located closer to the swing axis than a circumferential edge of the disk facing region, a circumferential edge of the arm swing region, and a circumferential edge of the driver mounting region when viewed from an axial direction.

4. The base plate according to claim 3, wherein at least a portion of a circumferential edge of the cut surface on an upper surface of the bottom wall is located inside an arc with a radius of about 9.0 mm centered on the swing axis when viewed from the axial direction, the circumferential edge facing the arm swing region in a radial direction.

5. The base plate according to claim 4, wherein the circumferential edge of the cut surface on the upper surface of the bottom wall includes a convex portion protruding outward in a radial direction of the swing axis and straight portions extending linearly in a circumferential direction from both ends of the convex portion in the circumferential direction when viewed from the axial direction, the circumferential edge facing the arm swing region in the radial direction.

6. The base plate according to claim 3, wherein at least a portion of a circumferential edge of the cut surface on a lower surface of the bottom wall overlaps an arc with a radius equal to a shortest distance between the swing axis and the driver mounting region when viewed from the axial direction, the circumferential edge facing the arm swing region in a radial direction.

7. The base plate according to claim 1, wherein
the cut surface is on each of the upper surface and the lower surface of the bottom wall; and
at least a portion of the cut surface on the upper surface of the bottom wall overlaps, in an axial direction, the cut surface on the lower surface of the bottom wall.

8. The base plate according to claim 1, wherein the cut surface includes a plurality of annular first cutting marks arranged continuously in a circumferential direction about the swing axis.

9. The base plate according to claim 1, wherein the cut surface includes a plurality of annular second cutting marks arranged concentrically about the swing axis.

10. The base plate according to claim 1, wherein the cut surface includes:
a plurality of circular first cutting marks arranged continuously in a circumferential direction about the swing axis; and
a plurality of second cutting marks located radially inward of the plurality of circular first cutting marks and arranged concentrically about the swing axis.

11. The base plate according to claim 1, wherein the bottom wall has a thickness of about 0.9 mm or more in the vertical direction at the cut surface.

12. A spindle motor comprising the base plate according to claim 1.

13. A disk drive device comprising:
the spindle motor according to claim 12;
a disk configured to be rotated by the spindle motor about the rotation axis; and
a head configured to read or write information from or to the disk.

14. The disk drive device according to claim 13, wherein the housing is filled with gas having a lower density than air.

15. A method for manufacturing a base plate defining a portion of a housing of a disk drive device, the method comprising, in this order:
a casting step of integrally casting, by using a mold, a bottom wall extending perpendicularly to a rotation axis of a disk, the rotation axis extending in a vertical direction and a swing axis of a head configured to read or write information from or to the disk, a pivot post protruding upward from an upper surface of the bottom wall along the swing axis, and a pedestal having an annular shape and protruding radially outward from an outer circumferential surface of a root portion of the pivot post; and
a precision cutting step of cutting a portion of the bottom wall; wherein
in the casting step, the bottom wall is integrally formed with a thick portion having a thickness of about 2.0 mm or more in the vertical direction in a peripheral region on a radially outer side of the pedestal; and
in the precision cutting step, the thick portion is cut, and a cut surface formed by cutting is formed on at least one of an upper surface or a lower surface of the bottom wall.

16. The method for manufacturing a base plate according to claim 15, wherein, in the precision cutting step, the thick portion is cut by moving a rotating cutting blade.

17. The method for manufacturing a base plate according to claim 15, wherein, in the precision cutting step, the thick portion is cut by rotating a cutting blade about the swing axis.

18. The method for manufacturing a base plate according to claim 17, wherein, in the precision cutting step, the cutting blade is located across an upper surface of the pedestal and an outer circumferential surface of the pedestal.

19. The method for manufacturing a base plate according to claim 15, wherein the bottom wall has a thickness of about 0.9 mm or more in the vertical direction after the precision cutting step.
